(19) United States
(12) Patent Application Publication
(10) Pub. No.: US 2023/0212398 A1
(43) Pub. Date: Jul. 6, 2023

(54) SYSTEM AND METHOD FOR MANUFACTURING PARTICLE BOARD FROM WASTE-WOOD POWDERS AND ITS COMPOSITION THEREOF

(71) Applicant: KING KHALID UNIVERSITY, Abha (SA)

(72) Inventors: KHALED MOHAMED KHEDHER, Abha (SA); VINEET TIRTH, Abha (SA); MOUTAZ MUSTAFA A. ELDIRDERI, Abha (SA)

(21) Appl. No.: 18/184,369

(22) Filed: Mar. 15, 2023

(51) Int. Cl. C08L 97/02; C08L 61/06; B27N 1/02; B27N 3/00; B27N 3/08

(52) U.S. Cl. CPC C08L 97/02; C08L 61/06; B27N 1/0209; B27N 3/007; B27N 3/08

(57) ABSTRACT

The system comprises a grinder for crushing and pulverizing waste phenolic polymer material, wood fiber and porous material to form a powder; a homogenizer for mixing waste phenolic polymer material powder uniformly with resin for bonding the powder of the waste phenolic polymer material, wherein resin is added for bonding the powder of the waste phenolic polymer material, the powder of wood fiber and powder of porous material; a mixing chamber for mixing powder of waste phenolic polymer material, wood fiber and porous material uniformly; a pressing device for applying one of the methods of hot pressing, cold pressing, injection by an injection machine, extrusion by an extruder, or foaming of the obtained mixture to form desired solid material; and an analysis unit for determining a physical and mechanical properties of these boards using a series of tests such as compressive, tensile, flexural, thickness swelling, water absorption, and moisture content.

### FIELD OF THE INVENTION

The present disclosure relates to a system and method for manufacturing particle board from waste-wood powders and composition of particle board. In more detail, the system is used to develop environment friendly Bakelite or wood for decoration and construction boards, furniture boards, or for external wall insulation, or in boards used in the printed circuit board industry, copper foil substrate industry processes, or in the general use of Bakelite.

### BACKGROUND OF THE INVENTION

In general, conventional wood-based fibreboards are made by wetting a binder (adhesive) such as a liquid synthetic resin with a fibrous substance such as pulp generated by defibrating and washing a powdered substrate. Following that, it is manufactured through dehydration, forming (forming), and press-moulding with a hot press. In terms of weight reduction and the like, such a wood fibre board has a reasonably low specific gravity, but it also has a poor mechanical strength, such as bending strength, and a low surface hardness.

Furthermore, the surface shine or smoothness is low. As a result, a surface material is bonded to the surface to improve the strength or improve the surface quality. Furthermore, a wood-based laminated board and a composite board are often made by wet laminating a wood chip material treated with a resin and a wood-based powder treated with a resin into an appropriate layer, shaping, and then applying heat and pressure using a hot press.

Moulding is used to make it, a hardwood laminate, composite board is typically made up of core material and surface material, or core material, intermediate material, and surface material are independently prepared to minimise weight, or they are laminated and integrally moulded. Alternatively, the surface material layer, the intermediate material layer, and the core material layer may be laminated on an appropriate layer, formed, and then moulded by heating and pressing with a hot press.

In one prior art solution (JPH11300711A), a wooden resin moulded article and material for it is disclosed. To provide a wooden resin moulded article prepared by moulding a powdery or granulate material containing a thermosetting resin comprising a ground product of a wooden waste material and a thermosetting resin represented by phenol resins as raw materials.

In another prior art solution (KR20020019815A), a method for producing a particle board using waste melamine and a phenol resin cosmetic plate is disclosed. The low-pressure melamine cosmetic sheet is dried sheet after impregnating raw paper (Raw Paper, Deco Paper) with phenol resin (Phenol Formaldehyde resin), melamine formaldehyde resin, and urea resin (Urea-formaldehyde resin), Is used as a product to improve the function and aesthetic appearance of the panel surface by attaching it to the panel surface with pressure at high temperature.

In the view of the forgoing discussion, it is clearly portrayed that there is a need to have a system and method for manufacturing particle board from waste-wood powders and composition of particle board.

### SUMMARY OF THE INVENTION

The present disclosure seeks to provide a method for manufacturing particle board from waste-wood powders and composition of particle board for developing environment friendly Bakelite or wood for decoration and construction boards, furniture boards, or for external wall insulation, or in boards used in the printed circuit board industry, copper foil substrate industry processes, or in the general use of Bakelite.

In an embodiment, a system for manufacturing particle board from waste-wood powders is disclosed. The system includes a grinder for crushing and pulverizing waste phenolic polymer material, wood fiber and porous material to form a powder.

The system further includes a homogenizer device for mixing the waste phenolic polymer material powder uniformly with resin for bonding the powder of the waste phenolic polymer material, wherein the resin is added for bonding the powder of the waste phenolic polymer material, the powder of the wood fiber and the powder of the porous material.

The system further includes a mixing chamber for mixing powder of waste phenolic polymer material, wood fiber and porous material uniformly.

The system further includes a pressing device for applying one of the methods of hot pressing, cold pressing, injection by an injection machine, extrusion by an extruder, or foaming of the obtained mixture to form the desired solid material.

The system further includes an analysis unit for determining physical and mechanical properties of these boards using a series of tests such as compressive, tensile, flexural, thickness swelling, water absorption, and moisture content.

In another embodiment, a method for manufacturing particle board from waste-wood powders is disclosed. The method includes crushing and pulverizing waste phenolic polymer material, wood fiber and porous material by a grinder to form a powder thereby mixing uniformly.

The method further includes immersing the powdered waste phenolic polymer material in one of the acidic or alkaline solution for subjecting the surface of the waste phenolic polymer material for eroding or disintegrating into powder form.

The method further includes adding resin and mixing uniformly for bonding the powder of the waste phenolic polymer material, the powder of the wood fiber and the powder of the porous material using mixing chamber.

The method further includes applying one of the methods of hot pressing, cold pressing, injection by an injection machine, extrusion by an extruder, or foaming of the obtained mixture to form the desired solid material through a pressing device.

Yet, in another embodiment, a composition for manufacturing particle board from waste-wood powders is disclosed. The composition includes a powder extract of waste phenolic polymer material, from 200-1000 grams; a powder extract of waste wood fiber, from 200-1000 grams; a powder extract of waste porous material, from 200-1000 grams; an aqueous extract of acidic or alkaline solution, from 10-100 milliliter; and an aqueous extract of resin, from 200-1000 grams.

An object of the present disclosure is to develop environment friendly Bakelite or wood for decoration and construction boards, furniture boards, or for external wall insulation, or in boards used in the printed circuit board industry, copper foil substrate industry processes, or in the general use of Bakelite.

Another object of the present disclosure is to widely increase the characteristics of waste fiber recycling, and achieve the goal of circular economy and the concept of environmental sustainability.

Another object of the present disclosure is to decrease the environmental load and increases the lifespan of incinerators and landfills.

Yet another object of the present invention is to deliver an expeditious and cost-effective system and method for manufacturing particle board from waste wood powders.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a system for manufacturing particle board from waste-wood powders in accordance with an embodiment of the present disclosure; and

FIG. 2 illustrates a flow chart of a method for manufacturing particle board from waste-wood powders in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION:

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

In an embodiment, a composition for manufacturing particle board from waste-wood powders is disclosed. The composition includes a powder extract of waste phenolic polymer material, from 200-1000 grams; a powder extract of waste wood fiber, from 200-1000 grams; a powder extract of waste porous material, from 200-1000 grams; an aqueous extract of acidic or alkaline solution, from 10-100 milliliter; and an aqueous extract of resin, from 200-1000 grams.

In another embodiment, the acidic or alkaline solution is selected from a group of aqua regia, H2SO4, HCl, HF, HNO3, aqueous potassium hydroxide, aqueous calcium hydroxide, aqueous sodium hydroxide, and hydrogen Acid-base aqueous solution including magnesium oxide aqueous solution.

In another embodiment, the phenolic polymer material, identified from a group of phenolic upper cover plate, Bakelite waste, bottom backing plate, and table top plate, wherein the wood fiber is selected from backing boards, green boards, waste wood pulp boards, or decorative or furniture boards or fresh fiber sources, wood flour, wood chips, or agricultural waste.

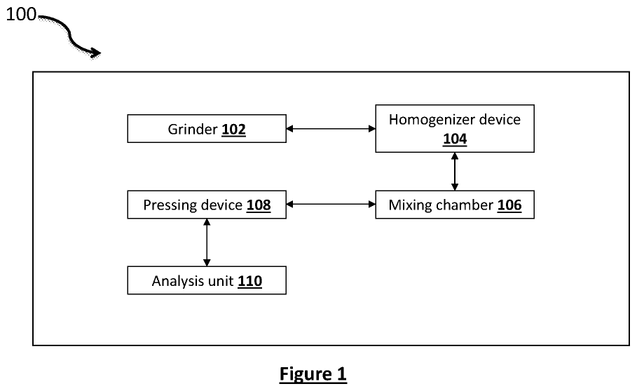

Referring to FIG. 1, a block diagram of a system for manufacturing particle board from waste-wood powders is illustrated in accordance with an embodiment of the present disclosure. The system 100 includes a grinder 102 for crushing and pulverizing waste phenolic polymer material, wood fiber and porous material to form a powder.

In an embodiment, a homogenizer device 104 is connected to the grinder 102 for mixing the waste phenolic polymer material powder uniformly with resin for bonding the powder of the waste phenolic polymer material, wherein the resin is added for bonding the powder of the waste phenolic polymer material, the powder of the wood fiber and the powder of the porous material.

In an embodiment, a mixing chamber 106 is connected to the homogenizer device 104 for mixing powder of waste phenolic polymer material, wood fiber and porous material uniformly.

In an embodiment, a pressing device 108 is connected to the mixing chamber 106 for applying one of the methods of hot pressing, cold pressing, injection by an injection machine, extrusion by an extruder, or foaming of the obtained mixture to form the desired solid material through a pressing device 108.

In an embodiment, an analysis unit 110 is connected to the pressing device 108 for determining a physical and mechanical properties of these boards using a series of tests such as compressive, tensile, flexural, thickness swelling, water absorption, and moisture content.

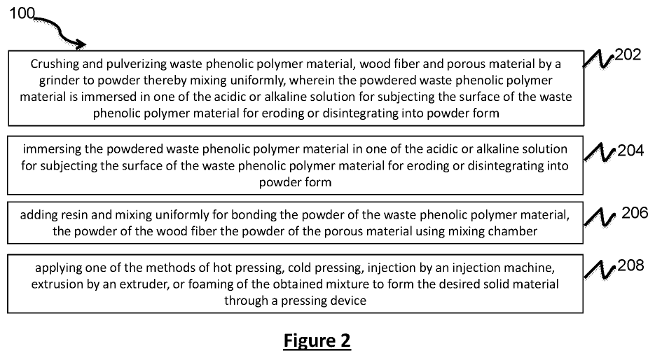

FIG. 2 illustrates a flow chart of a method for manufacturing particle board from waste-wood powders in accordance with an embodiment of the present disclosure. At step 202, the method 200 includes crushing and pulverizing waste phenolic polymer material, wood fiber and porous material by a grinder 102 to form a powder thereby mixing uniformly.

At step 204, the method 200 includes immersing the powdered waste phenolic polymer material in one of the acidic or alkaline solution for subjecting the surface of the waste phenolic polymer material for eroding or disintegrating into powder form.

At step 206, the method 200 includes adding resin and mixing uniformly for bonding the powder of the waste phenolic polymer material, the powder of the wood fiber the powder of the porous material using mixing chamber 106.

At step 208, the method 200 includes applying one of the methods of hot pressing, cold pressing, injection by an injection machine, extrusion by an extruder, or foaming of the obtained mixture to form the desired solid material through a pressing device 108.

In another embodiment, the weight ratio of the phenolic polymer material, wood fiber, porous material and resin are identical, wherein the pulverized wood-based material is having a particle size of 50-100 mesh passes.

In another embodiment, the obtained mixture is preferably applied hot pressing to form the solid material with 40 kgf/cm² pressure, wherein the hot-pressing temperature of 120-160° C. is applied for 1 hour.

In another embodiment, determining a physical and mechanical properties of the boards, wherein physical and mechanical properties of the boards are determined by using a series of tests such as compressive, tensile, flexural, thickness swelling, water absorption, and moisture content.

In another embodiment, the waste phenolic polymer material, wood fiber and porous material is dried on sunlight for 1 day after crushing and pulverizing to remove moisture content, wherein the waste phenolic polymer material, wood fiber and porous material is individually crushed, pulverized and sieved through 50-100 meshes.

In another embodiment, a homogenizer device 104 is deployed for mixing the waste phenolic polymer material powder uniformly with resin for bonding the powder of the waste phenolic polymer material.

The developed system 200 manufactures environment friendly Bakelite or wood for decoration and construction boards, furniture boards, or for external wall insulation, or in boards used in the printed circuit board industry, copper foil substrate industry processes, or in the general use of Bakelite. The system is used to widely increase the characteristics of waste fiber recycling, and achieve the goal of circular economy and the concept of environmental sustainability. The system is used to reduce the environmental load and increases the lifespan of incinerators and landfills.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for manufacturing particle board from waste-wood powders, the method comprises:
crushing and pulverizing waste phenolic polymer material, wood fiber and porous material by a grinder to form a powder thereby mixing uniformly;
immersing the powdered waste phenolic polymer material in one of the acidic or alkaline solution for subjecting the surface of the waste phenolic polymer material for eroding or disintegrating into powder form;
adding resin and mixing uniformly for bonding the powder of the waste phenolic polymer material, the powder of the wood fiber the powder of the porous material using mixing chamber; and
applying one of the methods of hot pressing, cold pressing, injection by an injection machine, extrusion by an extruder, or foaming of the obtained mixture to form the desired solid material through a pressing device.

2. The method claimed in claim 1, wherein the weight ratio of the phenolic polymer material, wood fiber, porous material and resin are identical, wherein the pulverized wood-based material is having a particle size of 50-100 mesh passes.

3. The method claimed in claim 1, wherein the obtained mixture is preferably applied hot pressing to form the solid material with 40 kgf/cm² pressure, wherein the hot-pressing temperature of 120-160° C. is applied for 1 hour.

4. The method claimed in claim 1, further comprises determining a physical and mechanical properties of the boards, wherein physical and mechanical properties of the boards are determined by using a series of tests such as compressive, tensile, flexural, thickness swelling, water absorption, and moisture content.

5. The method claimed in claim 1, wherein the waste phenolic polymer material, wood fiber and porous material is dried on sunlight for 1 day after crushing and pulverizing to remove moisture content, wherein the waste phenolic polymer material, wood fiber and porous material is individually crushed, pulverized and sieved through 50-100 meshes.

6. The method claimed in claim 1, wherein a homogenizer device is deployed for mixing the waste phenolic polymer material powder uniformly with resin for bonding the powder of the waste phenolic polymer material.

7. The method claimed in claim 1, wherein a composition comprises:
a powder extract of waste phenolic polymer material, from 200-1000 grams;
a powder extract of waste wood fiber, from 200-1000 grams;
a powder extract of waste porous material, from 200-1000 grams;
an aqueous extract of acidic or alkaline solution, from 10-100 milliliter; and
an aqueous extract of resin, from 200-1000 grams.

8. The method claimed in claims 1 and 7, wherein the acidic or alkaline solution is selected from a group of aqua regia, H₂SO₄, HCl, HF, HNO₃, aqueous potassium hydroxide, aqueous calcium hydroxide, aqueous sodium hydroxide, and hydrogen Acid-base aqueous solution including magnesium oxide aqueous solution.

9. The method claimed in claims 1 and 7, wherein the phenolic polymer material, identified from a group of phenolic upper cover plate, Bakelite waste, bottom backing plate, and table top plate, wherein the wood fiber is selected from backing boards, green boards, waste wood pulp boards, or decorative or furniture boards or fresh fiber sources, wood flour, wood chips, or agricultural waste.

10. A system for manufacturing particle board from waste-wood powders, the system comprises:
a grinder for crushing and pulverizing waste phenolic polymer material, wood fiber and porous material to form a powder;
a homogenizer device for mixing the waste phenolic polymer material powder uniformly with resin for bonding the powder of the waste phenolic polymer material, wherein the resin is added for bonding the powder of the waste phenolic polymer material, the powder of the wood fiber and the powder of the porous material;
a mixing chamber for mixing powder of waste phenolic polymer material, wood fiber and porous material uniformly;
a pressing device for applying one of the methods of hot pressing, cold pressing, injection by an injection machine, extrusion by an extruder, or foaming of the obtained mixture to form the desired solid material; and
an analysis unit for determining a physical and mechanical properties of these boards using a series of tests such as compressive, tensile, flexural, thickness swelling, water absorption, and moisture content.
